(19) United States
(12) Patent Application Publication
(10) Pub. No.: US 2005/0141526 A1
(43) Pub. Date: Jun. 30, 2005

(54) Spanning tree protection using dual switches for LAN service over SONET

(76) Inventors: Michael Charles Green, Central Valley, NY (US); David Michael Colven, Dallas, TX (US)

Correspondence Address: SWIDLER BERLIN LLP, 3000 K STREET, NW, BOX IP, WASHINGTON, DC, 20007, US

(21) Appl. No.: 10/747,223

(22) Filed: Dec. 30, 2003

(51) Int. Cl. H04L 12/28

(52) U.S. Cl. 370/401; 370/469

(57) ABSTRACT

According to the present invention, a LAN bridge connection scheme is used to connect each LAN service port (LSP) to two ethernet switch ports (ESP) of separate ethernet switches. The basic unit of the scheme is a three port LAN bridge that comprises a LSP and two ESPs. This structure is repeated for each LSP in the network. The bridge is redundant in that each LSP is connected over separate SONET connections to the ESP of a separate ethernet switch. The typical path of LAN data packets from one LSP to another is therefore LSP to ESP to ethernet switch to ESP to LSP. However, because the LAN bridge is redundant, the two ethernet switches initially are available to provide connections for the two redundant paths. The ethernet switches employ spanning tree protocol to make one only switch active and to therefore disable one of the redundant paths created by the LAN bridge. If, however, one of the paths between a LSP and ESP fails, the spanning tree protocol will act to enable the other ethernet switch to make the redundant path operative and thus provide data protection.

### FIELD OF THE INVENTION

The present invention relates to synchronous optical networks (SONET) and, more particularly, to a system and method for providing spanning tree protection using dual switches for local area network service over a SONET network.

### BACKGROUND OF THE INVENTION

Optical networks have become a standard technology for the transport of information in the telecommunications industry. A number of different optical network standards have been defined, with each having advantages and disadvantages for different uses. Synchronous optical network (SONET) is one standard for optical telecommunications transport. SONET is expected to provide the transport infrastructure for worldwide telecommunications for at least the next two or three decades. The increased configuration flexibility and bandwidth availability of SONET provides significant advantages over the older telecommunications system, such as reduction in equipment requirements, increase in network reliability, ability to carry signals in a variety of formats, a set of generic standards that enable products from different vendors to be connected, and a flexible architecture capable of accommodating future applications, with a variety of transmission rates. SONET is often used for long-haul, metro level, and access transport applications. In metropolitan areas, the access network often includes high-capacity synchronous optical network (SONET) rings, optical T3 lines, and copper-based T1s.

One use of SONET is to provide local area network (LAN) connectivity using GFP/ATM over SONET and then carry the LAN packets as frames and cells over the network. In order to provide complete LAN connectivity between all ports, when implementing statically provisioned circuits, one must provision at least one data circuit between each LAN port in the network. Each new LAN port added to the network then requires provisioning of every node in the network. Using wide area network (WAN) side source address learning to direct LAN packets on point-to-point data circuits to their destination LAN port, rather than broadcast LAN packets to all LAN ports in the network, may make efficient use of network bandwidth. This scheme may also some provide data path protection using SONET UPSR. This scheme is not, however, directly scalable to a large number of LAN ports on the same network because the number of other LAN bridged ports that can be connected to a single LAN bridged port is limited. For example, this limit may be less than 10.

The limit may be circumvented by using one LAN side ethernet port of a LAN bridge network to interconnect to similar ports on another LAN bridge network. This circumvention possibly crates a traffic bottleneck of data packets that cross between two LAN bridge networks.

Accordingly, there is a need for a technique to implement SONET to provide LAN connectivity between LAN service ports that provides data path protection. There is a further need for a technique to implement SONET to provide LAN connectivity between LAN service ports that makes efficient use of network bandwidth and that provides for the addition of new LAN ports to the network in a scalable fashion without requiring additional provisioning of every node in the network.

### SUMMARY OF THE INVENTION

According to the present invention, a LAN bridge connection scheme is used to connect each LAN service port (LSP) to two ethernet switch ports (ESP) of separate ethernet switches. The basic unit of the scheme is a three port LAN bridge that comprises a LSP and two ESPs. This structure is repeated for each LSP in the network. The bridge is redundant in that each LSP is connected over separate SONET connections to the ESP of a separate ethernet switch.

The typical path of LAN data packets from one LSP to another is therefore LSP to ESP to ethernet switch to ESP to LSP. However, because the LAN bridge is redundant, the two ethernet switches initially are available to provide connections for the two redundant paths. The ethernet switches employ spanning tree protocol to make one only switch active and to therefore disable one of the redundant paths created by the LAN bridge. If, however, one of the paths between a LSP and ESP fails, the spanning tree protocol will act to enable the other ethernet switch to make the redundant path operative and thus provide data protection.

According to an embodiment of the invention, a bridge for a SONET connected LAN includes two ethernet switch ports and a first LAN service port. The ethernet switch ports are associated with first and second ethernet switches. The LAN service port has first and second data paths between a user port and two ethernet switch ports. The data paths are implemented over SONET paths and all traffic carried between the ethernet switch ports is carried over the SONET connections between the ethernet switch ports and the first LAN service port. When a second LAN service port is part of the LAN, the first and second ethernet switches are coupled to the second LAN service port via separate ethernet switch ports. When the first data path is active, a failure of the first data path results in the spanning tree protocol being implemented to prevent the first ethernet switch from carrying data between the first LAN service port and the second LAN service port and to enable the second ethernet switch to carry data between the first LAN service port and the second LAN service port.

According to another embodiment of the invention, a method of implementing a LAN having SONET connectivity includes providing a first LAN service port having at least 3 ports. Two ethernet switch ports associated with separate first and second ethernet switches are also provided. The LAN service port is coupled to two ethernet switch ports via first and second SONET paths and to a user port in order to carry bi-directional traffic between the user port and the two ethernet switch ports. In this configuration, the method includes carrying all traffic between the ethernet switch ports over the first and second SONET paths. According to the method, the failure of one of the SONET paths results in spanning tree protocol being implemented at the ethernet switches to connect the other SONET path thereby rendering it operative.

### BRIEF DESCRIPTION OF THE FIGURES

The above described features and advantages of various embodiments of the invention will be more fully appreciated with reference to the attached drawings and detailed description.

FIG. 1 depicts a configuration of SONET interconnecting LANs.

FIG. 2 depicts a configuration of a LAN bridge incorporating a LAN service port (LSP) and two ethernet switch ports (ESP) according to an embodiment of the present invention.

FIG. 3A depicts a LAN bridge with one redundant path through an ethernet switch disabled according to an embodiment of the present invention.

FIG. 3B depicts a LAN bridge after the redundant path through an ethernet switch becomes operational pursuant to the spanning tree protocol due to a path failure.

### DETAILED DESCRIPTION

According to the present invention, a LAN bridge connection scheme is used to connect each LAN service port (LSP) to two ethernet switch ports (ESP) of separate ethernet switches. The basic unit of the scheme is a three port LAN bridge that comprises a LSP and two ESPs. This structure is repeated for each LSP in the network. The bridge is redundant in that each LSP is connected over separate SONET connections to the ESP of a separate ethernet switch.

The typical path of LAN data packets from one LSP to another is therefore LSP to ESP to ethernet switch to ESP to LSP. However, because the LAN bridge is redundant, the two ethernet switches initially are available to provide connections for the two redundant paths. The ethernet switches employ spanning tree protocol to make one only switch active and to therefore disable one of the redundant paths created by the LAN bridge. If, however, one of the paths between a LSP and ESP fails, the spanning tree protocol will act to enable the other ethernet switch to make the redundant path operative and thus provide data protection.

Overview of a SONET/LAN System

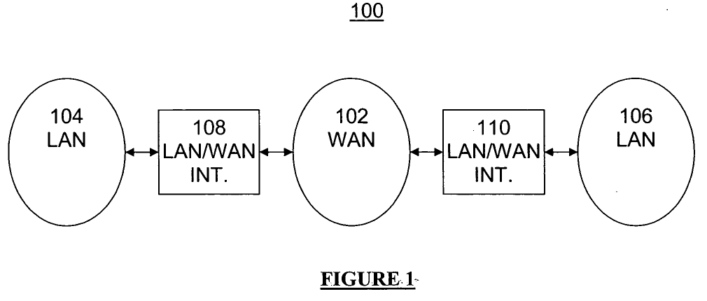

An exemplary block diagram of a system 100 in which the present invention may be implemented is shown in FIG. 1. System 100 includes a Wide Area Network 102 (WAN), one or more Local Area Networks 104 and 106 (LAN), and one or more LAN/WAN interfaces 108 and 110. A LAN, such as LANs 104 and 106, is computer network that spans a relatively small area. Most LANs connect workstations and personal computers. Each node (individual computer) in a LAN has its own CPU with which it executes programs, but it also is able to access data and devices anywhere on the LAN. This means that many users can share expensive devices, such as laser printers, as well as data. Users can also use the LAN to communicate with each other, by sending e-mail or engaging in chat sessions.

There are many different types of LANs, Ethernets being the most common for Personal Computers (PCs). Most Apple Macintosh networks are based on Apple's AppleTalk network system, which is built into Macintosh computers.

Most LANs are confined to a single building or group of buildings. However, one LAN can be connected to other LANs over any distance via longer distance transmission technologies, such as those included in WAN 102. A WAN is a computer network that spans a relatively large geographical area. Typically, a WAN includes two or more local-area networks (LANs), as shown in FIG. 1. Computers connected to a wide-area network are often connected through public networks, such as the telephone system. They can also be connected through leased lines or satellites. The largest WAN in existence is the Internet.

Among the technologies that may be used to implement WAN 102 are optical technologies, such as Synchronous Optical Network (SONET) and Synchronous Digital Hierarchy (SDH). SONET is a standard for connecting fiber-optic transmission systems. SONET was proposed by Bellcore in the middle 1980s and is now an ANSI standard. SONET defines interface standards at the physical layer of the OSI seven-layer model. The standard defines a hierarchy of interface rates that allow data streams at different rates to be multiplexed. SONET establishes Optical Carrier (OC) levels from 51.8 Mbps (about the same as a T-3 line) to 2.48 Gbps. Prior rate standards used by different countries specified rates that were not compatible for multiplexing. With the implementation of SONET, communication carriers throughout the world can interconnect their existing digital carrier and fiber optic systems.

SDH is the international equivalent of SONET and was standardized by the International Telecommunications Union (ITU). SDH is an international standard for synchronous data transmission over fiber optic cables. SDH defines a standard rate of transmission at 155.52 Mbps, which is referred to as STS-3 at the electrical level and STM-1 for SDH. STM-1 is equivalent to SONET's Optical Carrier (OC) levels-3.

LAN/WAN interfaces 108 and 110 provide electrical, optical, logical, and format conversions to signals and data that are transmitted between a LAN, such as LANs 104 and 106, and WAN 102.

The LAN Bridge Structure

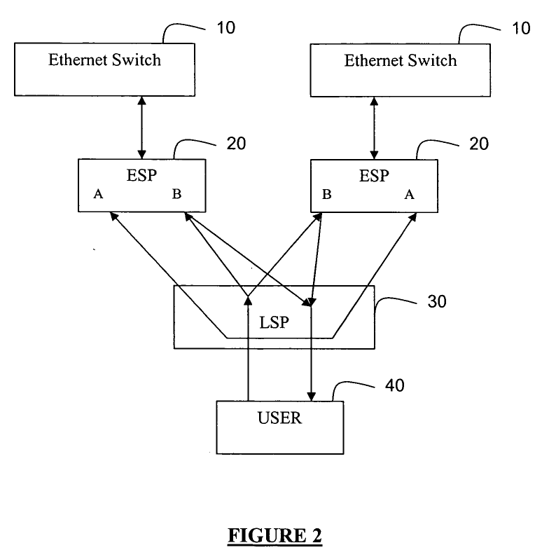

FIG. 2 depicts a view of a basic LAN bridge structure according to an embodiment of the present invention. Referring to FIG. 2, the LAN bridge structure includes two separate ethernet switches 10, each coupled to ESPs 20. The communication between ESPs 20 and the ethernet switches may be via any convenient ethernet protocol. Two ESPs 20 are in turn coupled to the LSP 30. The LSP 30 is a 5 port device and includes bi-directional ports coupling each ESP to the user 40. The bi-directional ports communicating with the user at each ESP are indicated in FIG. 2 as B ports. The ESPs 20 are further shown to have A ports, which are coupled together through two additional LSP ports. The traffic communicated between the A ports includes data used to implement the spanning tree protocol. The connections between the ESPs and the LSP are preferably made via SONET path connections. For example, the connections may be implemented pursuant to SONET STS1 or VT protocols.

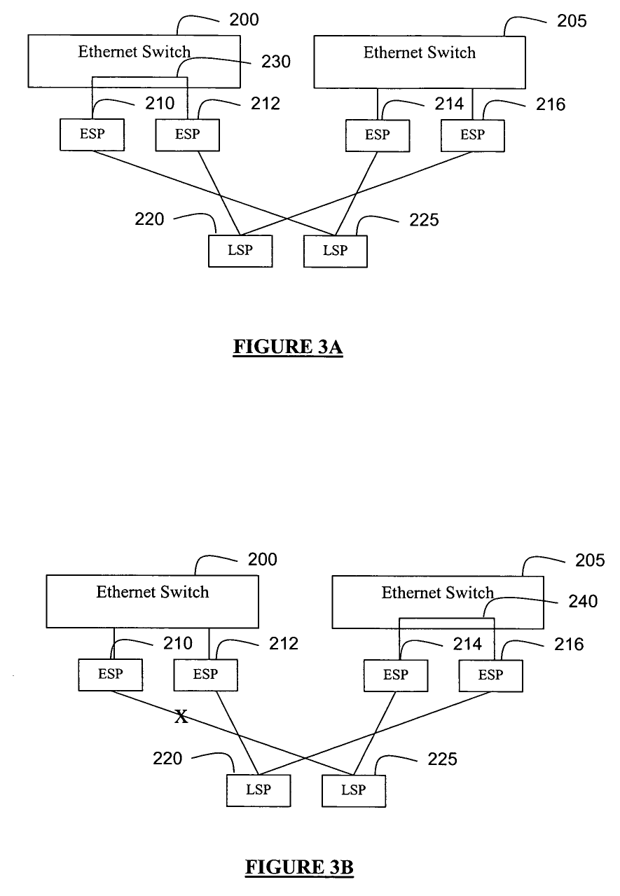

FIG. 3A depicts a LAN bridge with one redundant path through an ethernet switch according to an embodiment of the present invention. Referring to FIG. 3A, the basic LAN bridge structure is shown within an illustrative network incorporating two LSPs 220 and 225. Each LSP is coupled to two ESPs. LSP 220 is coupled to ESP 212 and 216. LSP 225 is coupled to ESP 210 and 216. LSPs 210 and 212 are coupled to ethernet switch 200 and LSPs 214 and 216 are coupled to ethernet switch 205.

According to this configuration, each LSP has the possibility of two redundant connections to the other LSP tracing the path LSP, ESP, ethernet switch, ESP, LSP. For both connections to be operative, both ethernet switches 200 and 205 would have to create the connection between ESP 210 and ESP 212 and ESP 214 and ESP 216. In practice, however, the spanning tree protocol is implemented by the ethernet switches and one of these redundant connections within the ethernet switches is disconnected. In FIG. 3A, the connection within ethernet switch 205 is disabled while the connection within ethernet switch 200 is shown enabled. This is useful to reduce redundant message traffic within the network.

FIG. 3B depicts a LAN bridge after the redundant path through an ethernet switch becomes operational pursuant to the spanning tree protocol due to a path failure. FIG. 3B reflects the same network configuration as FIG. 3A, however, referring to FIG. 3B, the path between LSP 225 and ESP 210 has failed. In this scenario, the message traffic from the A and B ports of the ESP 210 and the LSP 225 fail and traffic from the A port of ESP 210 no longer reaches ESP 214. This triggers the spanning tree protocol, which causes the redundant connection to be made between ESP 214 and 216 within ethernet switch 205 as shown. The redundant connection compensates for the broken path and creates a new path through ethernet switch 205 for carrying traffic between the LSP 225 and the LSP 220. In order for the spanning tree protocol to be properly invoked, the ESP to ESP traffic is carried through the LSP so that when an ESP to LSP path fails, the ESP to ESP path also fails.

When a SONET ring is used to implement LAN connectivity between the LSPs and ESPs, generally all of the ESPs are implemented in one or two nodes. There are generally multiple LSPs per SONET ring node. When a new LSP is added to the network, only network elements that contain the new LSP and ESPs to which the LSP is connected are provisioned. This is accomplished by pre-assigning groups of data circuit identifies to each network element. This allow network elements that do not contain ESPs to be pre-provisioned to pass-through data packets with circuit identifiers that are not in their pre-assigned group of identifiers.

While particular embodiments of the present invention have been shown and described, it will be understood by those having ordinary skill in the art that changes may be made to those embodiments without departing from the spirit and scope of the invention.

1. A bridge for a SONET connected LAN, comprising:
two ethernet switch ports associated with first and second ethernet switches; and
a first LAN service port, the LAN service port having first and second data paths between a user port and two ethernet switch ports, the data paths being implemented over SONET connections;
wherein traffic carried between the ethernet switch ports is carried over the SONET connections between the ethernet switch ports and the first LAN service port.

2. The bridge according to claim 1, wherein the first ethernet switch carries data between the first LAN service port and a second LAN service port coupled to the first and second ethernet switch.

3. The bridge according to claim 2, wherein a failure of the first data path results in spanning tree protocol being implemented to prevent the first ethernet switch from carrying data between the first LAN service port and the second LAN service port and to enable the second ethernet switch to carry data between the first LAN service port and the second LAN service port.

4. The bridge according to claim 3, wherein the SONET connections employ the STS 1 protocol.

5. The bridge according to claim 3, wherein the SONET connections employ the VT protocol.

6. A method of implementing a LAN having SONET connectivity with a bridge, comprising:
providing a first LAN service port having at least 3 ports;
providing two ethernet switch ports associated with separate first and second ethernet switches;
coupling the LAN service port to two ethernet switch ports via first and second SONET paths and to a user port in order to carry bidirectional traffic between the user port and the two ethernet switch ports;
carrying traffic between the ethernet switch ports over the first and second SONET paths.

7. The method according to claim 6, wherein the first ethernet switch carries data between the first LAN service port and a second LAN service port coupled to the first and second ethernet switch.

8. The method according to claim 7, wherein a failure of the first SONET path results in spanning tree protocol being implemented to prevent the first ethernet switch from carrying data between the first LAN service port and the second LAN service port and to enable the second ethernet switch to carry data between the first LAN service port and the second LAN service port.

9. The method according to claim 8, wherein the SONET connections employ the STS 1 protocol.

10. The method according to claim 8, wherein the SONET connections employ the VT protocol.
